(19) United States
(12) Patent Application Publication
(10) Pub. No.: US 2026/0042191 A1
(43) Pub. Date: Feb. 12, 2026

(54) Adjustable Wrench Device with Improved Jaw Adjustment Mechanism

(71) Applicant: HANDY FAMM IP HOLDINGS, LLC, Boca Raton, FL (US)

(72) Inventor: Joshua White, Boca Raton, FL (US)

(21) Appl. No.: 19/281,050

(22) Filed: Jul. 25, 2025

Related U.S. Application Data
(60) Provisional application No. 63/679,956, filed on Aug. 6, 2024.

(51) Int. Cl. B25B 13/14; B25B 13/24

(52) U.S. Cl. CPC B25B 13/14; B25B 13/24

(57) ABSTRACT

The disclosed technology includes an adjustable wrench. In one example, the adjustable wrench may include a head and a handle coupled to the head. The head may include a housing that defines a housing cavity, a fixed jaw coupled to the housing, and a jaw adjustment mechanism coupled to the housing. The jaw adjustment mechanism may include an adjustable jaw including an adjustable jaw component positioned parallel to the fixed jaw and a lever arm positioned at least partially within the housing cavity. The lever arm may engage with the adjustable jaw. Movement of the lever arm may move the adjustable jaw towards the fixed jaw.

### CROSS REFERENCE TO RELATED APPLICATIONS

The present application claims the benefit of priority to U.S. Provisional Ser. No. 63/679,956 , entitled “Adjustable Wrench Device with Improved Jaw Adjustment Mechanism” filed Aug. 6, 2024, the entirety of which is hereby incorporated by reference herein for all purposes.

### TECHNICAL FIELD

The technology described herein relates generally to an adjustable wrench with an improved jaw adjustment mechanism.

### BACKGROUND

Adjustable wrenches, also called crescent wrenches, are hand tools used to tighten or loosen nuts or bolts. Crescent wrenches have an adjustable jaw that allows a user to use the crescent wrench on nuts or bolts of different sizes by adjusting the jaw size. The adjustable jaw is adjusted by a worm screw positioned just below the head or above the handle of the wrench. The worm screw may be turned to adjust the sizing of the jaw to fit a specific bolt or nut. Adjusting the jaws to clasp a conventional bolt or nut or to release the jaws from the bolt or nut typically requires multiple turns of the worm screw, taking time and energy to adjust the jaws in either direction.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes wrenches with improved jaw adjustment devices. Embodiments of the present disclosure may include an adjustable wrench. The adjustable wrench may include a head that includes a housing and a fixed jaw coupled to the housing. The housing may define a housing cavity. A handle may be coupled to the head. A jaw adjustment mechanism may be coupled to the housing. The jaw adjustment mechanism may include an adjustable jaw having an adjustable jaw component positioned parallel to the fixed jaw and a lever arm positioned at least partially within the housing cavity. The lever arm may engage with the adjustable jaw. Movement of the lever arm may move the adjustable jaw towards the fixed jaw.

Other examples or embodiments of the present disclosure may include a jaw adjustment mechanism for an adjustable wrench. The jaw adjustment mechanism may include an adjustable jaw that includes an adjustable jaw component and an adjustable jaw wall coupled to the adjustable jaw component on a first side and positioned perpendicular to the adjustable jaw component. The adjustable jaw wall may include a rack on a second side. The jaw adjustment mechanism may include a lever arm that includes a first lever arm end and a second lever arm end, wherein the first lever arm end engages with the rack. Movement of the second lever arm end in a direction away from the adjustable jaw may push the rack and the adjustable jaw in a direction closer to a fixed jaw of the adjustable wrench.

Additional examples or embodiments of the present disclosure may include an adjustable wrench. The adjustable wrench may include a head and a handle coupled to the head. The head may include a housing that defines a housing cavity and that defines a lever aperture on a top surface of the housing. A fixed jaw may be coupled to a top portion of the housing and a jaw adjustment mechanism may be coupled to a bottom portion of the housing. The jaw adjustment mechanism may include an adjustable jaw and a lever arm that extends through the lever aperture and into the housing cavity. The adjustable jaw may include an adjustable jaw component coupled to an adjustable jaw wall on a first side of the adjustable jaw wall, wherein the adjustable jaw component is perpendicular to the adjustable jaw wall and parallel to the fixed jaw. The lever arm may engage with the adjustable jaw wall on a second side of the adjustable jaw wall. Movement of the lever arm may move the adjustable jaw towards the fixed jaw.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a front isometric view of an adjustable wrench with an improved jaw adjustment mechanism.

FIG. 2 is a front elevation view of the adjustable wrench of FIG. 1.

FIG. 3 is a front isometric exploded view of the adjustable wrench of FIG. 1.

FIG. 4 is a rear isometric exploded view of the adjustable wrench of FIG. 1.

FIG. 5 is a front isometric view of the housing cavity of the adjustable wrench of FIG. 1.

FIG. 6 is a rear isometric view of the housing cavity of FIG. 5.

FIG. 7 is a bottom plan view of the housing and the handle of the adjustable wrench of FIG. 1.

FIG. 8 is a left side top isometric view of the adjustable jaw of the adjustable wrench of FIG. 1.

FIG. 9 is a right side isometric view of the adjustable jaw of FIG. 8.

FIG. 10A is a rear isometric view of the internal jaw release button of the adjustable wrench of FIG. 1.

FIG. 10B is a rear isometric view of a different embodiment of the internal jaw release button that can be included with the adjustable wrench of FIG. 1.

FIG. 11 is a left side isometric view of the lever arm of the adjustable wrench of FIG. 1.

FIG. 12 is a rear elevation view of the lever arm of FIG. 11.

FIG. 13 is a left side isometric view of the locking mechanism of the adjustable wrench of FIG. 1.

FIG. 14 is a front elevation view of the locking mechanism of FIG. 13.

FIG. 15 is a front isometric view of the head of the adjustable wrench of FIG. 1 with the jaw release button removed.

FIG. 16 is a top plan view of the jaw adjustment mechanism of the adjustable wrench of FIG. 1.

FIG. 17 is a zoomed-in front isometric view of the head of the adjustable wrench of FIG. 1 with the jaw release button and lever spring removed.

FIG. 18 is a zoomed-in cross section view of the head of the adjustable wrench of FIG. 1 taken along line 18-18.

FIG. 19A is a rear elevation cross section view of the head of the adjustable wrench of FIG. 1 taken along line 19-19 including an alternate embodiment of a jaw adjustment mechanism in an open position.

FIG. 19B is a rear elevation cross section view of the head of the adjustable wrench of FIG. 1 taken along line 19-19 with the jaw adjustment mechanism of FIG. 19A in a closed position.

FIG. 20 is a bottom isometric view of another embodiment of an adjustable wrench with an improved jaw adjustment mechanism.

FIG. 21 is a front elevation view of the head of the adjustable wrench of FIG. 20 with the front housing and the jaw release button removed to show the internal component parts of the adjustable wrench of FIG. 20.

FIG. 22 is a bottom isometric view of the fixed jaw of the adjustable wrench of FIG. 20.

FIG. 23 is a left side top isometric view of the adjustable jaw of the adjustable wrench of FIG. 20.

FIG. 24 is a right side isometric view of the adjustable jaw of FIG. 23.

FIG. 25 is a left side isometric view of the locking mechanism of the adjustable wrench of FIG. 20.

FIG. 26 is a rear right side isometric view of the jaw release button of the adjustable wrench of FIG. 20

FIG. 27 is a rear right isometric view of the head of the adjustable wrench of FIG. 20 with the rear housing removed.

FIG. 28 is a front elevation view of the head of the adjustable wrench of FIG. 20 with the front housing and the jaw release button removed to show the internal component parts of the alternate embodiment of the adjustable wrench of FIG. 20.

FIG. 29 is a zoomed-in top isometric view of the internal mechanical components of the jaw adjustment mechanism of the adjustable wrench of FIG. 28.

### DETAILED DESCRIPTION

This disclosure is related to an improved adjustable wrench. A disclosed improved adjustable wrench includes an improved jaw adjustment mechanism. A disclosed adjustable wrench may include a handle coupled to a head. The head may include a first jaw and a second jaw or a top and bottom jaw. One or both of the first and second jaws may be adjustable. One of the first and second jaws may be fixed. The top jaw may be fixed and the bottom jaw may be adjustable, or vice versa. The first and second jaws are spaced apart a distance D. At least one of the jaws may be moved relative to the other jaw to adjust the distance D a desired amount. For example, the desired amount of distance D may depend on a size of a nut or bolt that the improved adjustable wrench is used with. The adjustable jaw may move towards or away from the other jaw when the jaw adjustment mechanism is operated.

The jaw adjustment mechanism may include a lever arm that is configured to be pulled or pushed away from the adjustable wrench jaws by a user to move the jaws closer together or to close the jaws, e.g., to clasp a fastener. In some embodiments, the lever arm engages with the adjustable jaw and is configured to push the adjustable jaw towards the other jaw.

The lever arm may move the adjustable jaw incremental distances. For example, the lever arm may have a lever tooth that engages with one or more rack teeth of the adjustable jaw. The lever tooth may be a gear tooth of a gear that is coupled to the lever. As one end of the lever arm is moved away from the jaws, the lever tooth, at the other end of the lever arm, may push up on a rack tooth and may move the adjustable jaw towards the other jaw. In some embodiments, the lever tooth moves the adjustable jaw towards the other jaw an incremental distance until the lever tooth slides into the next spacing between adjustable jaw rack teeth.

The jaw adjustment mechanism may include a jaw spring and a locking mechanism. The jaw spring may engage with the adjustable jaw and the other jaw and may create a separation force between the two jaws, pushing the jaws away from one another. The locking mechanism may engage with the adjustable jaw and may place a counter force on the adjustable jaw, i.e., a force on the adjustable jaw that is in the opposite direction from the separation force exerted by the jaw spring, holding the adjustable jaw in place so that it does not move away from the other jaw.

The jaw adjustment mechanism may include a jaw release button that, when pushed by a user, moves the adjustable jaw in a direction away from the other jaw or opens the jaws. The jaw release button may move the locking mechanism away from the adjustable jaw, such that the counter force is no longer exerted on the adjustable jaw. When the counter force is removed, the separation force exerted by the jaw spring may push the adjustable jaw away from the other jaw. In this manner, the adjustable wrench jaws may open and unlatch or disengage a fastener with a push of the jaw release button. The lever arm may reset into its original position and be moved again as described above to close the jaws. In some embodiments, the jaw release button may be omitted and the lever arm moved in the opposite direction to open the jaws and to reset the lever arm.

In some embodiments, a disclosed improved adjustable wrench may include two handles or handle arms. The two handle arms may facilitate holding the adjustable wrench and positioning the adjustable wrench relative to a fastener. For example, it may be easier for a user with reduced coordination or dexterity, such as a child or elderly individual, to hold a disclosed adjustable wrench with two hands to position the jaws around a fastener.

Disclosed improved adjustable wrenches provide improvements over conventional adjustable wrenches. Conventional adjustable wrenches use a worm screw to adjust the jaws of the wrench to a desired distance. A user may hold the lever and use the user's thumb to turn the worm screw and adjust the opening. However, the placement of the worm screw is not ideal for children with smaller fingers who may not be able to easily turn the worm screw with their thumb while holding the lever. The worm screw may also be difficult for others with poor dexterity, such as elderly users. Further, the worm screw takes time and energy as it takes multiple rotations to get the jaws to the desired spacing. Disclosed adjustable wrenches resolve these issues by including an improved jaw adjustment mechanism that is easier and quicker to use than conventional worm screws to adjust the wrench jaw spacing.

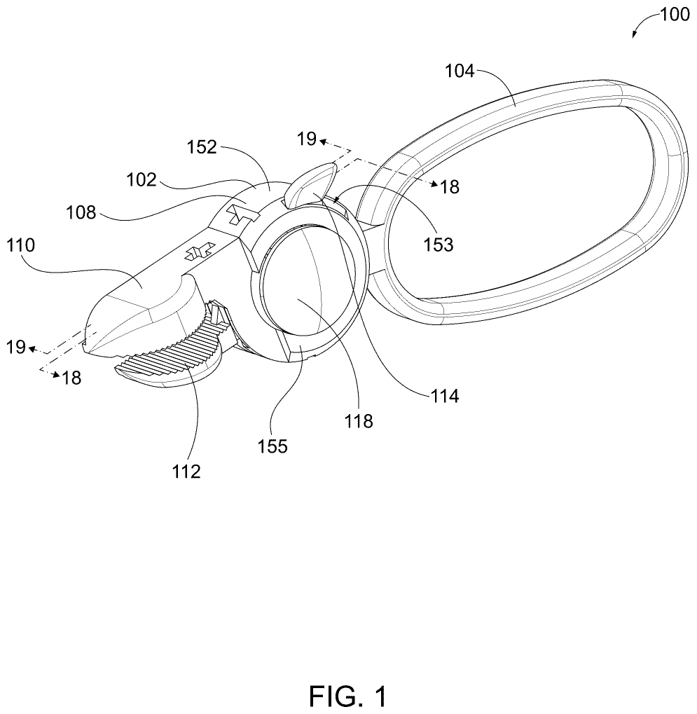

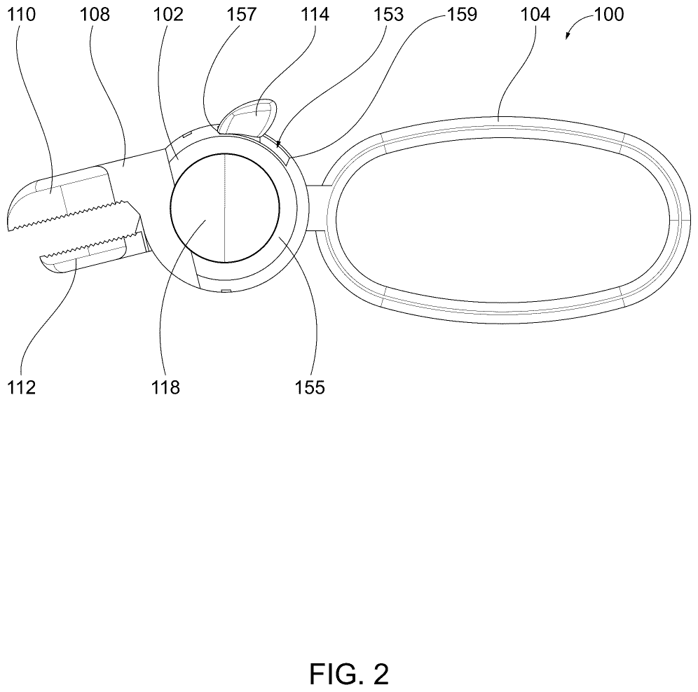

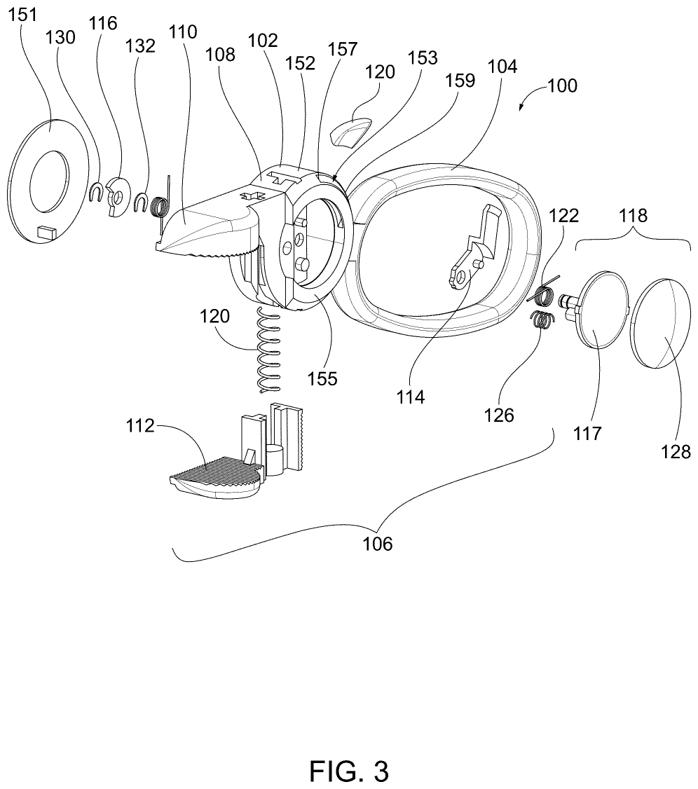

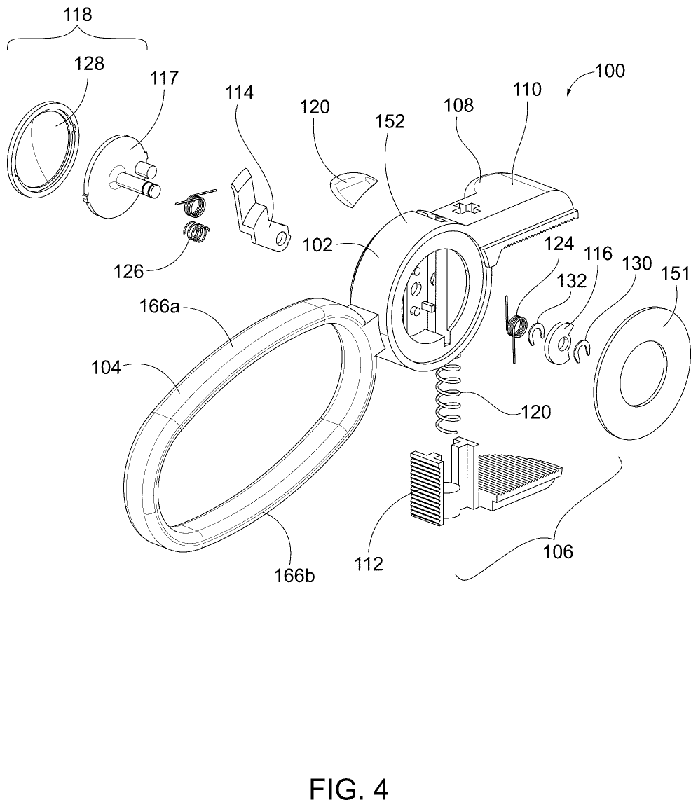

Turning to the figures, adjustable wrench embodiments of the present disclosure will now be discussed in more detail. FIG. 1 is a front isometric view of an adjustable wrench with an improved jaw adjustment mechanism. FIG. 2 is a front elevation view of the adjustable wrench of FIG. 1. FIG. 3 is a front isometric exploded view of the adjustable wrench of FIG. 1. FIG. 4 is a rear isometric exploded view of the adjustable wrench of FIG. 1. As shown, the adjustable wrench 100 may include a head 102, a handle 104, and a jaw adjustment mechanism 106. The adjustable wrench 100, specifically the head 102, may include a housing 108. The head 102 may include a fixed jaw 110. The jaw adjustment mechanism 106 may include an adjustable jaw 112, a lever arm 114, a locking mechanism or ratchet 116, a jaw release button 118, and one or more springs. The one or more springs may include one or more of a jaw spring 120, a lever spring 122, a locking spring 124, and a button spring 126. The jaw release button 118 may include an internal jaw release button 117 coupled to a button cover 128; however, it is contemplated that the jaw release button 118 may be made of a single component. The jaw adjustment mechanism 106 may include a plurality of fasteners 130, 132 to hold components in place. As shown, the fasteners 130, 132 have a horseshoe shape; however, the fasteners may be any shape with a central aperture, including, for example, a circular shape such as a washer. The fasteners 130, 132 may be spring clips that hold an object therebetween in position.

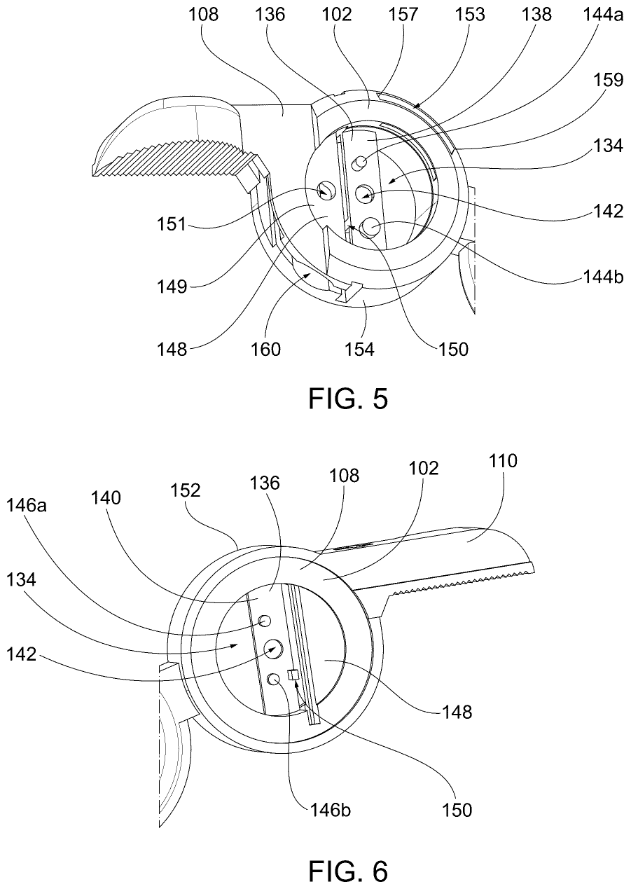

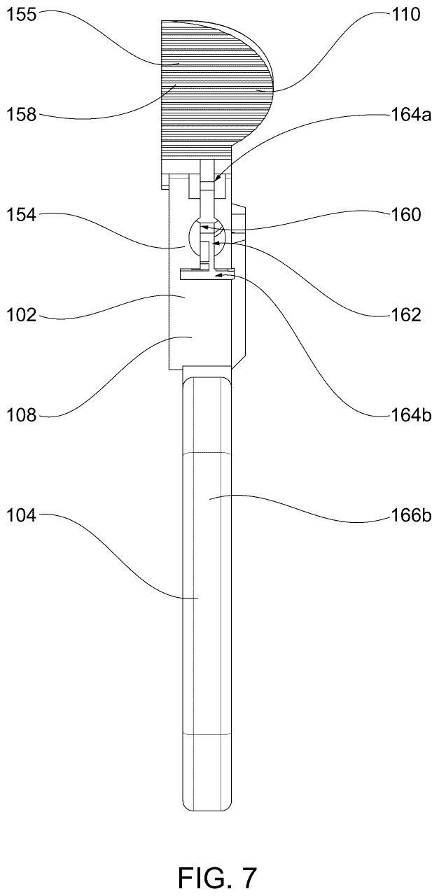

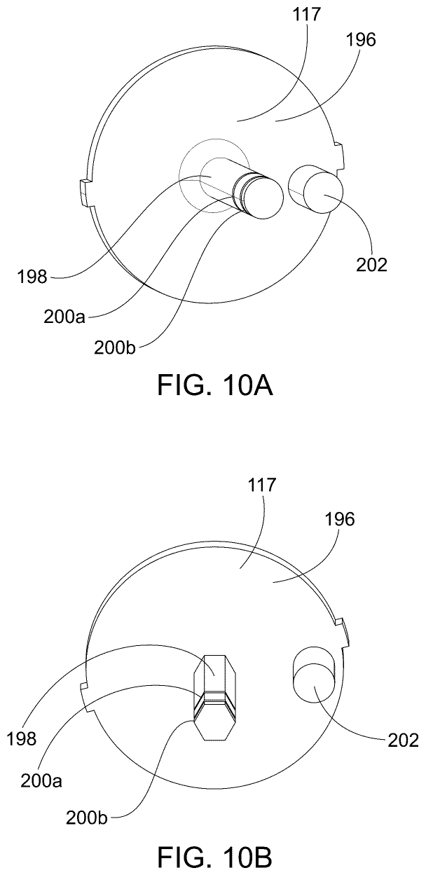

The head 102 and housing 108 will now be discussed in more detail with respect to FIGS. 1-7. FIG. 5 is a front isometric view of a housing cavity 134 of the adjustable wrench 100 of FIG. 1. FIG. 6 is a rear isometric view of the housing cavity 134 of FIG. 5. FIG. 7 is a bottom plan view of the housing 108 and the handle 104 of the adjustable wrench 100 of FIG. 1. The housing 108 may define a housing cavity 134 within the head 102 of the adjustable wrench 100. The adjustable wrench 100 may include a jaw adjustment mechanism holder 136 positioned inside the housing cavity 134. The jaw adjustment mechanism holder 136 may be a narrow vertical wall positioned vertically within the housing cavity 134 (e.g., in an orientation perpendicular to the fixed jaw 110 and adjustable jaw 112). The jaw adjustment mechanism holder 136 may include a holder front surface 138 and a holder rear surface 140. The jaw adjustment mechanism holder 136 may define a holder aperture 142. The shape of the holder aperture 142 may correspond to the shape of the central boss 198, which is described in more detail below with respect to FIGS. 10A-B. For example, the holder aperture 142 may have a cylindrical shape, e.g., to match the shape of the central boss 198 of FIG. 10A, or a hexagonal shape, e.g., to match the shape of the central boss 198 of FIG. 10B. A first and second front holder boss 144a, b, respectively, may extend outward from the holder front surface 138, positioned on opposing sides of the holder aperture 142. A first and second rear holder boss 146a,b may extend outward from the holder rear surface 140, positioned on opposing sides of the holder aperture 142. The adjustable wrench 100 may include a jaw spring compartment 148. The jaw spring compartment 148 may include a compartment housing 149 that defines a compartment aperture 151. The jaw spring compartment 148 may be spaced apart from the jaw adjustment mechanism holder 136 by a gap 150.

As shown, the housing 108 may include a housing rear wall 151, a housing top surface 152, a housing bottom surface 154, and a housing front surface 155. A lever aperture 153 may be defined in the housing 108. As shown, the lever aperture 153 is defined at least partially in or proximate to the housing top surface 152. The lever aperture 153 may be defined at least partially in or proximate to the housing front surface 155. The lever aperture 153 may be a slit or slot defined in the head 102. The lever aperture 153 may be formed along a portion of the circumference of the head 102. The lever aperture 153 may have a length that is defined between a first end 157 of the lever aperture 153 and a second end 159 of the lever aperture 153.

The head 102 may include the fixed jaw 110. The fixed jaw 110 may be coupled to the housing 108. The fixed jaw 110 may extend outward from the housing top surface 152 in a horizontal direction. The fixed jaw 110 may have a fixed jaw bottom surface 156 that includes a plurality of fixed jaw teeth 158. The plurality of fixed jaw teeth 158 may facilitate gripping of an object.

The housing bottom surface 154 may define an adjustable jaw aperture 160. The adjustable jaw aperture 160 may have a size and shape that corresponds to the size and shape of the adjustable jaw 112. For example, as shown, the adjustable jaw aperture 160 has a central circular aperture 162 positioned between a first and second T-shaped aperture 164a,b, respectively. The central circular aperture 160 provides access to the jaw spring compartment 148 and the second T-shaped aperture 164b provides access to the gap 150. It is contemplated that the adjustable jaw aperture 160 may be omitted.

The handle 104 may extend outward from the head 102 in an opposing direction from the fixed jaw 110. In the depicted embodiment, the handle 104 includes a top handle arm 166a and a bottom handle arm 166b; however, it is contemplated that the handle 104 may include a single arm, similar to a conventional wrench. In the depicted embodiment, the top and bottom handle arms 166a,b are connected forming an oval shape; however, it is contemplated that the top and bottom handle arms 166a,b may be separated by a gap. The two handle arms 166a,b of the handle 104 may facilitate use of the adjustable wrench 100 by allowing a user to grip the adjustable wrench 100 with two hands, improving the user's ability to align the adjustable wrench 100 with a fastener and keep the adjustable wrench 100 in a stable position. This feature of the adjustable wrench 100 may be particularly beneficial to a child, elderly individual, or other individual with limited coordination and/or dexterity, as it can be more challenging to hold a conventional wrench in one hand.

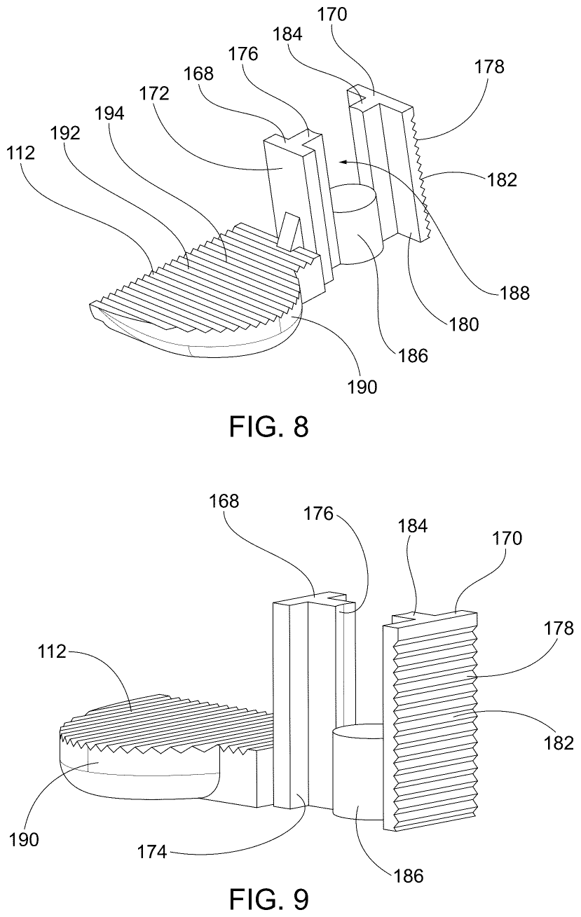

Components of the jaw adjustment mechanism 106 of the adjustable wrench 100 of FIG. 1 will now be discussed in more detail. FIG. 8 is a left side top isometric view of the adjustable jaw 112 of the adjustable wrench of FIG. 1. FIG. 9 is a right side isometric view of the adjustable jaw 112 of FIG. 8. As shown the adjustable jaw 112 may include a left adjustable jaw wall 168 and a right adjustable jaw wall 170. The left adjustable jaw wall 168 may include an outer left adjustable jaw wall surface 172 and an inner left adjustable jaw wall surface 174. The left adjustable jaw wall 168 may include a left adjustable jaw wall rectangular boss 176 that extends out from the inner left adjustable jaw wall surface 174, such that the left adjustable jaw wall 168 forms a T-shape. The right adjustable jaw wall 170 may include an outer right adjustable jaw wall surface 178 and an inner right adjustable jaw wall surface 180. The outer right adjustable jaw wall 178 may include a rack 182. The rack 182 may include a plurality of rack teeth. The plurality of rack teeth may be positioned vertically along a height of the outer right adjustable jaw wall 178. The right adjustable jaw wall 170 may include a right adjustable jaw wall rectangular boss 184 that extends out from the inner right adjustable jaw wall surface 180, such that the right adjustable jaw wall 170 forms a T-shape. It is contemplated that the left and right adjustable jaw wall rectangular bosses 176, 184 may be omitted. It is contemplated that one of the left adjustable jaw wall 168 and the right adjustable jaw wall 170 may be omitted and the adjustable jaw 112 may include a single wall.

A spacer 186 may be positioned between the left adjustable jaw wall 168 and the right adjustable jaw wall 170 forming a jaw spring gap 188 therebetween. Specifically, the spacer 186 may be positioned between the left and right adjustable jaw wall rectangular bosses 176, 184. As shown, the spacer 186 has a cylindrical shape; however, other shapes are contemplated. Where the adjustable jaw 112 includes a single wall, the spacer 186 may be omitted.

An adjustable jaw component 190 may be coupled to one of the left or right adjustable jaw walls 168, 170. As shown, the adjustable jaw component 190 is coupled to the left adjustable jaw wall 168, specifically to the outer left adjustable jaw wall surface 172. The adjustable jaw component 190 may be perpendicular to the left adjustable jaw wall 168 and the right adjustable jaw wall 170. The adjustable jaw component 190 may include an adjustable jaw component top surface 192 that includes a plurality of adjustable jaw teeth 194. The plurality of adjustable jaw teeth 194 may facilitate gripping of an object.

FIGS. 10A-B show different embodiments of the internal jaw release button 117 that may be included with the adjustable wrench 100 of FIG. 1. As shown, the internal jaw release button 117 may include a rear jaw release button surface 196. A central boss 198 may extend outward from the rear jaw release button surface 196. As shown in the embodiment depicted in FIG. 10A, the central boss 198 may have a cylindrical shape. In other embodiments, for example as shown in FIG. 10B, the central boss 198 may have a hexagonal shape. It is contemplated that the central boss 198 may have a prism shape with n number of sides. A plurality of notches or recessed rings 200a,b may be defined in the central boss 198. A second release button boss 202 may extend from the rear jaw release button surface 196. As shown, the second release button boss 202 may have a cylindrical shape.

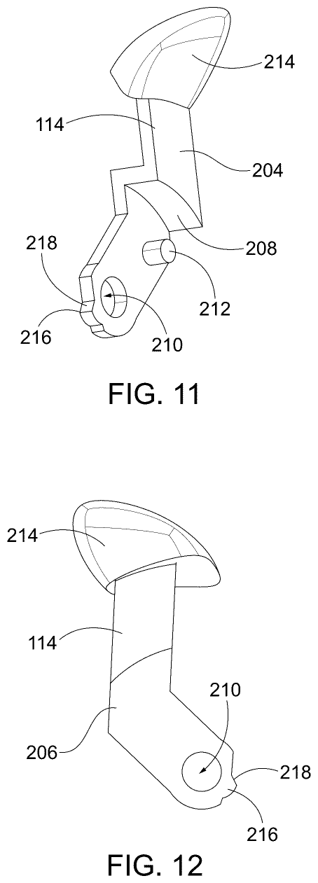

FIG. 11 is a left side isometric view of the lever arm 114 of the adjustable wrench 100 of FIG. 1. FIG. 12 is a rear elevation view of the lever arm 114 of FIG. 11. The lever arm 114 may include a front lever surface 204 and a rear lever surface 206. The front lever surface 204 may include a step or ridge 208. The front lever surface 204 may define a lever arm aperture 210 therethrough. The shape of the lever arm aperture 210 may correspond to the shape of the central boss 198. For example, the lever arm aperture 210 may have a cylindrical shape, e.g., to match the shape of the central boss 198 of FIG. 10A, or a hexagonal shape, e.g., to match the shape of the central boss 198 of FIG. 10B. A cylindrical lever boss 212 may extend out from the front lever surface 204, near or proximate to the lever arm aperture 210. The lever arm 114 may include a first end and a second end. The first end of the lever arm 114 may include a lever grip 214. The lever grip 214 may have an ergonomic shape that facilitates a user pushing or pulling the lever arm 114 with one or more fingers. The lever arm 114 may include a lever tooth or pinion gear 216 at an opposing end from the lever grip 214, e.g., at the second end. The lever tooth 216 may include a sloped lever tooth surface 218. The lever tooth 216 may be a gear tooth of a pinion gear.

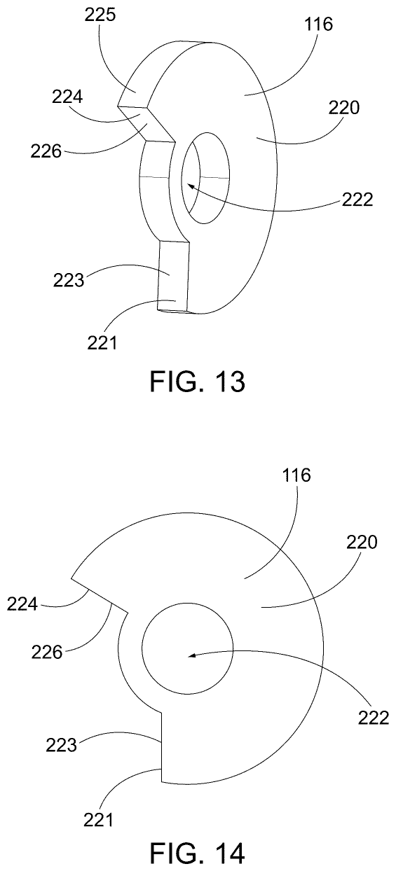

FIG. 13 is a left side isometric view of the locking mechanism 116 of the adjustable wrench 100 of FIG. 1. FIG. 14 is a front elevation view of the locking mechanism 116 of FIG. 13. As shown, the locking mechanism 116 may have a partially cylindrical body 220. The partially cylindrical body 220 may define a locking mechanism aperture 222 therethrough. The shape of the locking mechanism aperture 222 may correspond to the shape of the central boss 198. For example, the locking mechanism aperture 222 may have a cylindrical shape, e.g., to match the shape of the central boss 198 of FIG. 10A, or a hexagonal shape, e.g., to match the shape of the central boss 198 of FIG. 10B. The locking mechanism 116 may include a bottom locking tooth or ridge 221 and a top locking tooth or ridge 224. The bottom locking tooth or ridge 221 may include a bottom locking tooth engagement surface 223. The bottom locking tooth engagement surface 223 may be curved and/or sloped. As shown, the bottom locking tooth engagement surface 223 is sloped. The top locking tooth or ridge 224 may include a top top locking tooth surface 225 and a bottom top locking tooth surface 226. The top top locking tooth surface 225 may be curved and/or sloped. As shown, the top top locking tooth surface 225 is curved. The bottom top locking tooth surface 226 may be curved and/or sloped. As shown, the bottom top locking tooth surface 226 is sloped. While a cylindrical shaped body is depicted, it is contemplated that the shape of the locking mechanism 116 may vary.

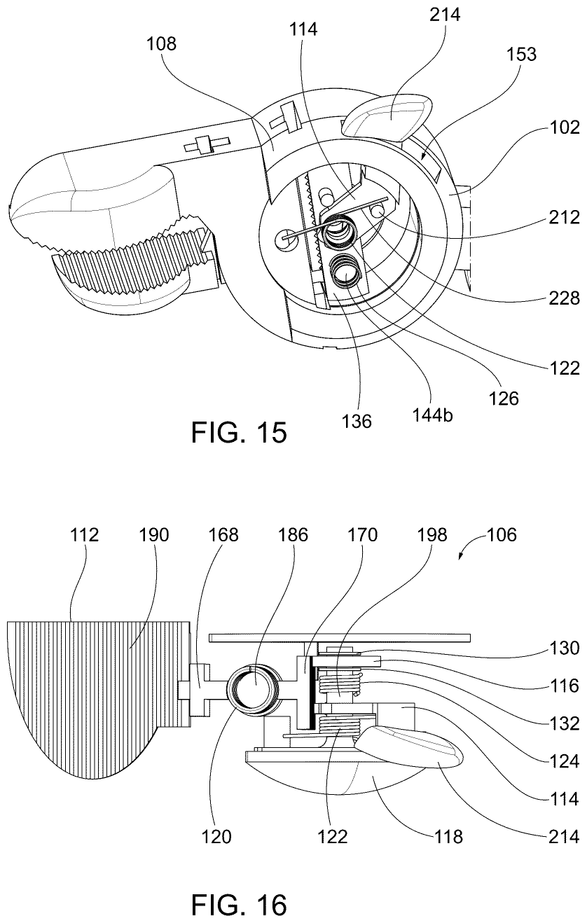

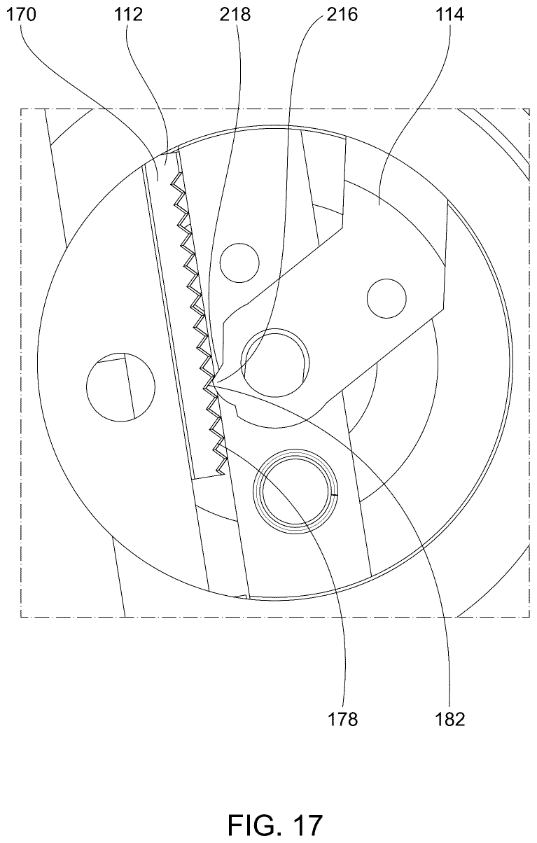

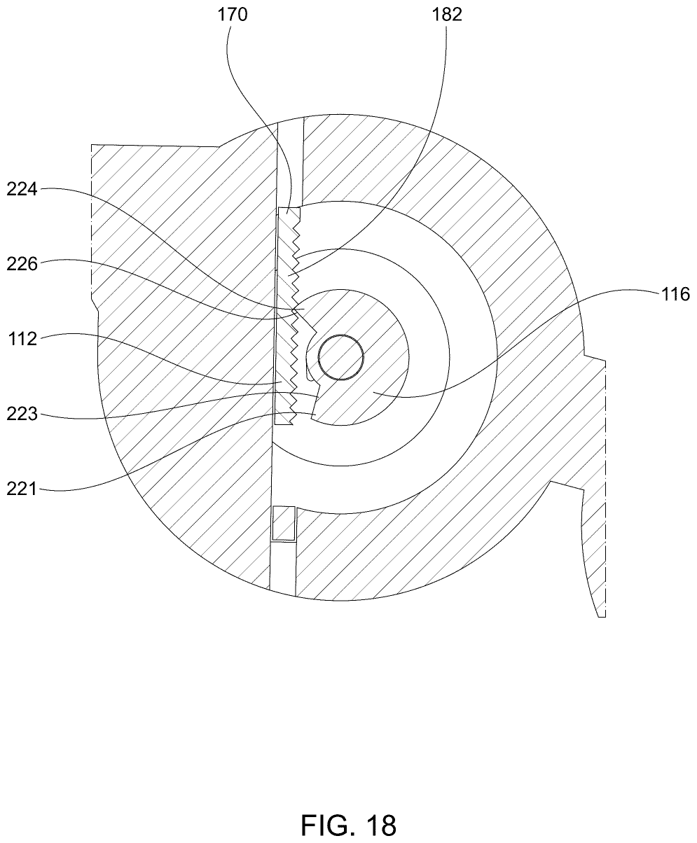

The arrangement of the components of the adjustable wrench 100 of FIG. 1 will now be discussed in more detail. FIG. 15 is a front isometric view of the head 102 of the adjustable wrench 100 of FIG. 1 with the jaw release button 118 removed. FIG. 16 is a top plan view of the jaw adjustment mechanism 106 of the adjustable wrench 100 of FIG. 1. FIG. 17 is a zoomed-in front isometric view of the head 102 of the adjustable wrench 100 of FIG. 1 with the jaw release button 118 and lever spring 122 removed. FIG. 18 is a zoomed-in cross section view of the head 102 of the adjustable wrench 100 of FIG. 1 taken along line 18-18. As shown, the adjustable jaw 112 is coupled to the housing 108. The adjustable jaw 112 may be positioned within the head 102, specifically within the adjustable jaw aperture 160. Specifically, as shown, the left adjustable jaw wall 168 is positioned inside the first T-shaped aperture 164a, the right adjustable jaw wall 170 is positioned inside the second T-shaped aperture 164b, such that the right adjustable jaw wall 170 sits in the gap 150, and the spacer 186 is positioned within the central circular aperture 162, such that the spacer 186 sits inside the jaw spring compartment 148. The jaw spring 120 is positioned above the spacer 186 inside the jaw spring compartment 148 and between the left adjustable jaw wall 168 and the right adjustable jaw wall 170. The jaw spring 120 may place a downward vertical pressure on the adjustable jaw 112 or a separation force between the adjustable jaw 112 and the fixed jaw 110. When in position, the adjustable jaw 112 may form the bottom jaw and the fixed jaw 110 may form the top jaw of the wrench jaws. Specifically, the adjustable jaw component 190 may form the bottom jaw. The adjustable jaw component 190 may be positioned parallel to the fixed jaw 110.

The jaw release button 118 may be positioned within a circular opening to the housing cavity 134. The internal jaw release button 117 may be positioned inside the housing cavity 134 and may be coupled to the button cover 128. The second release button boss 202 may be positioned within the compartment aperture 151 to hold the jaw release button 118 in place. The central boss 198 of the jaw release button 118 may be positioned through the lever spring 122, through the lever arm aperture 210 of the lever arm 114, through the holder aperture 142 of the jaw adjustment mechanism holder 136, through the locking spring 124, and through the locking mechanism aperture 222 of the locking mechanism 116. In some embodiments, e.g., where the central boss 198 has a hexagonal shape (e.g., as shown in FIG. 10B), the lever arm 114 may be fixedly coupled to the central boss 198. In some embodiments, the positioning of the central boss 198 through the lever arm aperture 210 may create a hinge for the lever arm 114. In other words, the lever arm 114 may be rotably or hingedly coupled to the central boss 198. In some embodiments, the locking mechanism 116 may be fixedly coupled to the central boss 198. The fasteners 130, 132 may be positioned within the notches or recessed rings 200a,b on opposing sides of the locking mechanism 116, holding the locking mechanism 116 in place on the central boss 198. A spring extension 228 of the lever spring 122 may be coupled to or biased against the cylindrical lever boss 212. The button spring 126 may be coupled to the second front holder boss 144b of the jaw adjustment mechanism holder 136 and may be positioned between the jaw adjustment mechanism holder 136 and the jaw release button 118.

A portion of the lever arm 114 may extend through the lever aperture 153 such that one end of the lever arm 114, e.g., the lever grip 214, is positioned outside the housing 108 of the head 102. In the depicted position, with the lever arm 114 positioned above the head 102, the lever arm 114 may be easily pulled by a user, e.g., with the user's thumb. It is contemplated that the lever arm 114 may be positioned elsewhere relative to the head 102, such as under the head 102 and towards the handle 104. In this position, the lever arm 114 may be used as a trigger and pulled by a user, e.g., with the user's index finger.

The lever arm 114 may engage with the adjustable jaw 112. Specifically, the lever tooth 216 may engage with the rack 182 on the outer right adjustable jaw wall 178. As shown in FIG. 17, the sloped lever tooth surface 218 may have a slope that matches and aligns with a slope on a bottom surface of a rack 182 tooth.

The locking mechanism 116 may engage with the adjustable jaw 112. The bottom locking tooth or ridge 221 or the top locking tooth or ridge 224 may engage with the rack 182 on the right adjustable jaw wall 170. As shown in FIG. 18, the bottom top locking tooth surface 226 may have a slope that matches and aligns with a slope on a top surface of a rack 182 tooth. The bottom locking tooth engagement surface 223 may have a slope that matches and aligns with a slope on a bottom surface of a rack 182 tooth.

In operation, movement of the lever arm 114, e.g., movement of the end of the lever arm 114 positioned outside the housing 108, in a direction away from the fixed jaw 110 and towards the handle 104 may move the adjustable jaw 112 in an upward direction toward the fixed jaw 110. In some embodiments, the lever arm 114 may be moved in increments within the lever aperture 153. In some embodiments, the lever arm 114 may be moved along the entire length of the lever aperture 153, from the first end 157 to the second end 159 of the lever aperture 153. As the lever arm 114 (or the end of the lever arm 114) moves away from the fixed jaw 110 or from the first end 157 to the second end 159, the lever tooth 216 may push upwards on the rack 182, moving the adjustable jaw 112 in an upward direction towards the fixed jaw 110. The lever tooth 216 may slide along the bottom surface of a rack 182 tooth until it releases from the rack 182 tooth to engage with a second rack 182 tooth adjacent to and above the first rack 182 tooth. The lever spring 122 may facilitate the movement of the lever tooth 216 from one rack 182 tooth to the next. Once the lever tooth 216 is engaged with the next rack 182 tooth, the adjustable jaw 112 may then be moved upwards again by moving the lever arm 114, which pushes the lever tooth 216 upwards against the rack 182 tooth to which it is engaged. The incremental movements of the lever arm 114 may coincide with typical dimensions of a fastener. For example, the lever arm 114 may move in 1/16″ increments, which coincides with typical 1/16″ variations in fasteners. Other distances are contemplated based on sizes of conventional fasteners, such as 1/32″, 1/64″, and the like increments. The adjustable jaw 112 may move in the same increments or the same distance as the lever arm 114. For example, movement of the lever arm 114 1/16″ or 1/32″ moves the adjustable jaw 112 1/16″ or 1/32″, respectively. In some embodiments, movement of the lever arm 114 from the first end 157 to the second end 159 of the lever aperture 153 may move the adjustable jaw 112 an incremental distance that coincides with a typical dimension of a fastener. For example, movement of the lever arm 114 from the first end 157 to the second end 159 may move the adjustable jaw 1/16″, 1/32″, 1/64″, and the like. In these embodiments, the distance the lever arm 114 moves may be different than the incremental distance that the adjustable jaw 112 moves. The adjustable jaw 112 may be moved in increments until it is a distance away from the fixed jaw 110 that coincides with a diameter of a typical fastener to securely tighten around the fastener. Moving the adjustable jaw 112 in increments may facilitate learning (e.g., by a child), assisting the user in understanding how to effectively clasp a fastener with the adjustable wrench 100. It is also contemplated that the lever arm 114 may be moved a desirable distance by a user and not in increments. The lever arm 114 may lock into place once released by a user, e.g., via the locking mechanism 116.

In some embodiments, movement of the lever arm 114 may turn the central boss 198 in a clockwise direction, which may turn the locking mechanism 116 in a clockwise direction. The movement of the locking mechanism 116 may correspond to movement of the lever arm 114. For example, the locking mechanism 116 may move the same incremental distance along the rack 182 as the lever arm 114 moves. The locking mechanism 116 may move from one rack 182 tooth to another rack 182 tooth adjacent to and above the initial rack 182 tooth as the lever arm 114 is moved. As shown in FIG. 18, the top locking tooth or ridge 224 may move from one rack 182 tooth to an adjacent rack 182 tooth. The locking spring 124 may facilitate movement of the locking mechanism 116 relative to the rack 182. The jaw spring 120 may place a downward force on the adjustable jaw 112 or a separation force between the adjustable jaw 112 and the fixed jaw 110 and the locking mechanism 116 may prevent the adjustable jaw 112 from moving in a downward direction away from the fixed jaw 110. The top top locking tooth surface 225 may push up against the bottom surface of the rack 182 tooth to which the locking mechanism 116 is engaged, creating an upward or counter force on the adjustable jaw 112 that counters the downward force or separation force created by the jaw spring 120, maintaining the position of the adjustable jaw 112.

As the lever arm 114 is moved and the locking mechanism 116 turns in a clockwise direction, the top locking tooth or ridge 224 may disengage from the rack 182 and the bottom locking tooth or ridge 221 may engage with the rack 182 to maintain the upwards force on the adjustable jaw 112. Specifically, the bottom locking tooth engagement surface 223 may push up against the bottom surface of the rack 182 tooth to which the locking mechanism 116 is engaged.

The jaw release button 118 may move inwards towards the housing cavity 134 to release the adjustable jaw 112 from a fastener or otherwise move it away from the fixed jaw 110 and open the jaws. Movement of the jaw release button 118 inwards may compress the button spring 126 and may move the central boss 198 and the locking mechanism 116 that is coupled thereto in a direction towards the rear housing wall 151. The locking mechanism 116 may be disengaged from the rack 182. When the locking mechanism 116 is disengaged, the downward or separation force of the jaw spring 120 acting on the adjustable jaw 112 may push the adjustable jaw 112 in a direction away from the fixed jaw 110 (e.g., a downward direction) until the jaw spring 120 is in an extended position (and the jaw is in a fully open position) or the locking mechanism 116 is reengaged with the rack 182 by releasing the jaw release button 118. Releasing the jaw release button 118 may move the jaw release button 118 back to its original position.

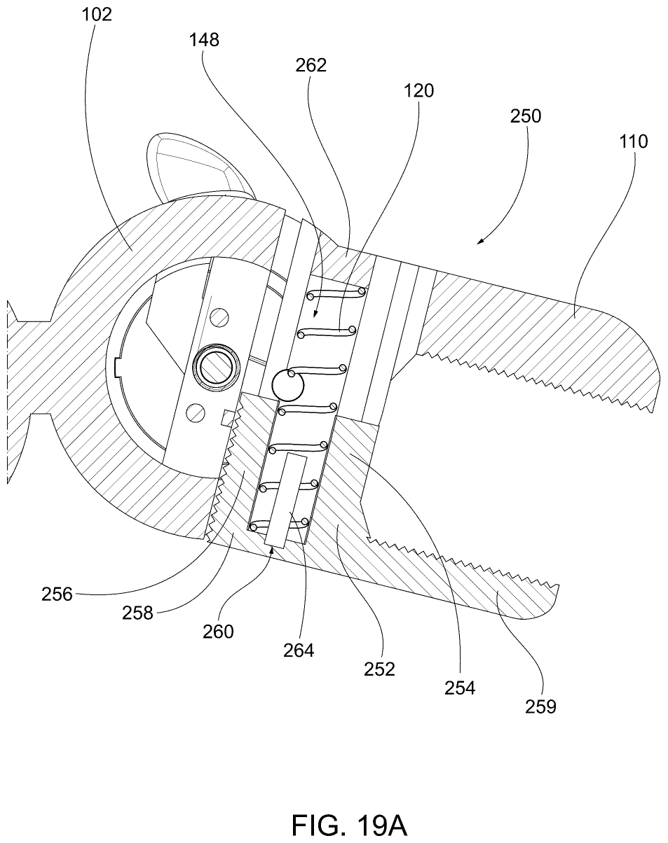

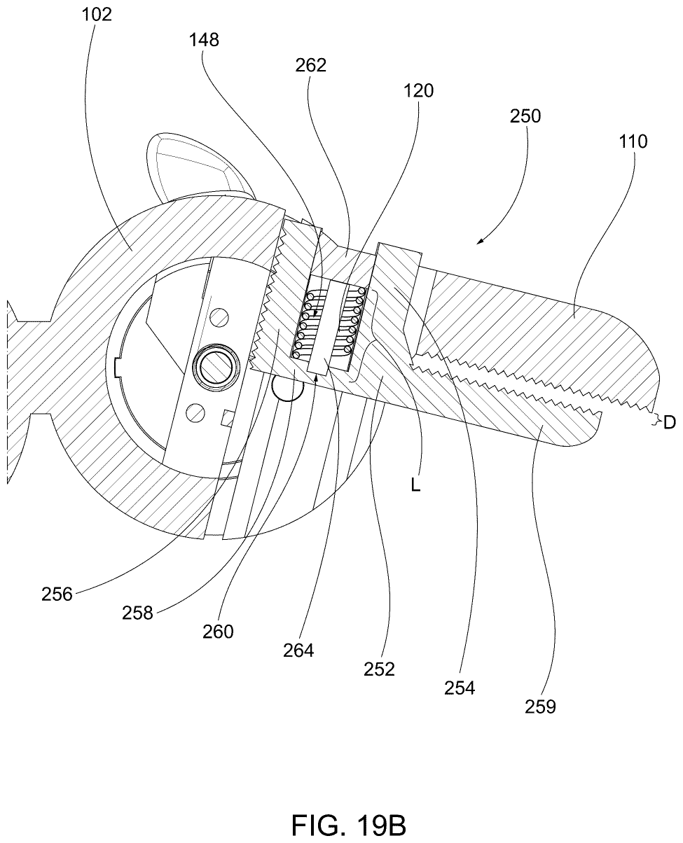

FIGS. 19A-B show an alternate embodiment of a jaw adjustment mechanism that includes a jaw stopper. FIG. 19A is a rear elevation cross section view of the head 102 of the adjustable wrench 100 of FIG. 1 taken along line 19-19 including an alternate embodiment of a jaw adjustment mechanism 250 in an open position. FIG. 19B is a rear elevation cross section view of the head 102 of the adjustable wrench of FIG. 1 taken along line 19-19 with the jaw adjustment mechanism 250 of FIG. 19A in a closed position. The jaw adjustment mechanism 250 may include similar or the same features as the jaw adjustment mechanism 106 described above with respect to FIGS. 1-18. For example, the jaw adjustment mechanism 250 may include an adjustable jaw 252 coupled to the head 102. The adjustable jaw 252 may include a left adjustable jaw wall 254 and a right adjustable jaw wall 256 separated by a bottom jaw wall 258 (similar to the spacer 186 described with respect to FIGS. 1-18). An adjustable jaw component 259 may be coupled to the left adjustable jaw wall 254 and may extend parallel to the fixed jaw 110. The bottom jaw wall 258 may include a bottom jaw wall recess 260 defined therein. The jaw spring 120 may be positioned in the jaw spring compartment 148, positioned between the bottom jaw wall 258 and an upper jaw wall 262. The jaw adjustment mechanism 250 may include a jaw stopper 264. In the depicted embodiment, the jaw stopper 264 is a pin. The jaw stopper 264 may be positioned within the jaw spring compartment 148. The jaw stopper 264 may be positioned within the bottom jaw wall recess 260 and/or coupled to the bottom jaw wall 258. The jaw stopper 264 may be concentric with the jaw spring 120. The jaw stopper 264 may have a length L.

As shown in FIG. 19B, when the jaw is in the closed position, the jaw stopper 264 may contact the upper jaw wall 262. The jaw stopper 264 may prevent the adjustable jaw component 259 from contacting the fixed jaw 110. The length L of the jaw stopper 264 may control the distance D between the adjustable jaw component 259 and the fixed jaw 110 when the jaw is in the closed position. The length L of the jaw stopper 264 may be adjusted to adjust the distance D between the adjustable jaw component 259 and the fixed jaw 110 when the jaw is in the closed position. For example, a longer length L will create more distance D between the adjustable jaw component 259 and the fixed jaw 110. By creating distance between the adjustable jaw component 259 and the fixed jaw 110, the jaw stopper 264 may allow for a safety margin, e.g., preventing users from pinching themselves between the jaws.

While the disclosed adjustable wrench 100 is depicted with a fixed jaw 110 as the top jaw, it is contemplated that the top jaw may be an adjustable jaw, e.g., similar to the adjustable jaw 112 described above, and may engage with the jaw adjustment mechanism 106 in a similar manner as described herein with respect to the adjustable jaw 112. The jaw adjustment mechanism 106 components may operate in opposing directions relative to the top adjustable jaw than described above with respect to the adjustable jaw 112. For example, a lever arm (e.g., the lever arm 114 described above or one that is similar to, but separate from, the lever arm 114) may push in a downward direction against the top adjustable jaw to move the top adjustable jaw downward toward the bottom jaw. A locking mechanism (e.g., the locking mechanism 116 described above or one that is similar to, but separate from, the locking mechanism 116) may push in a downward direction against the top adjustable jaw to counter the force of the jaw spring 120 and hold the top adjustable jaw in place. In these embodiments, the bottom jaw may be the adjustable jaw 112 described above or the bottom jaw may be a fixed jaw.

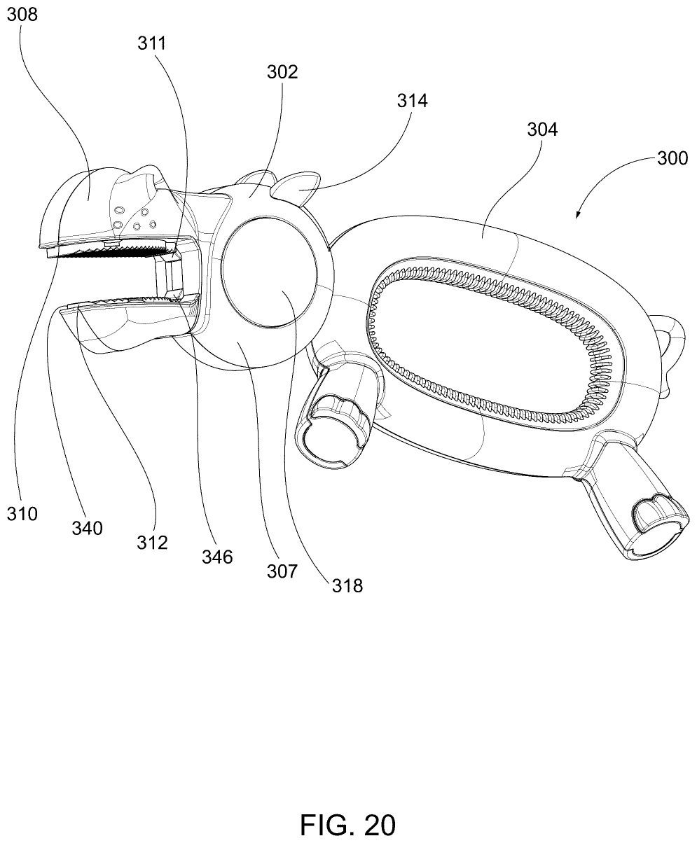

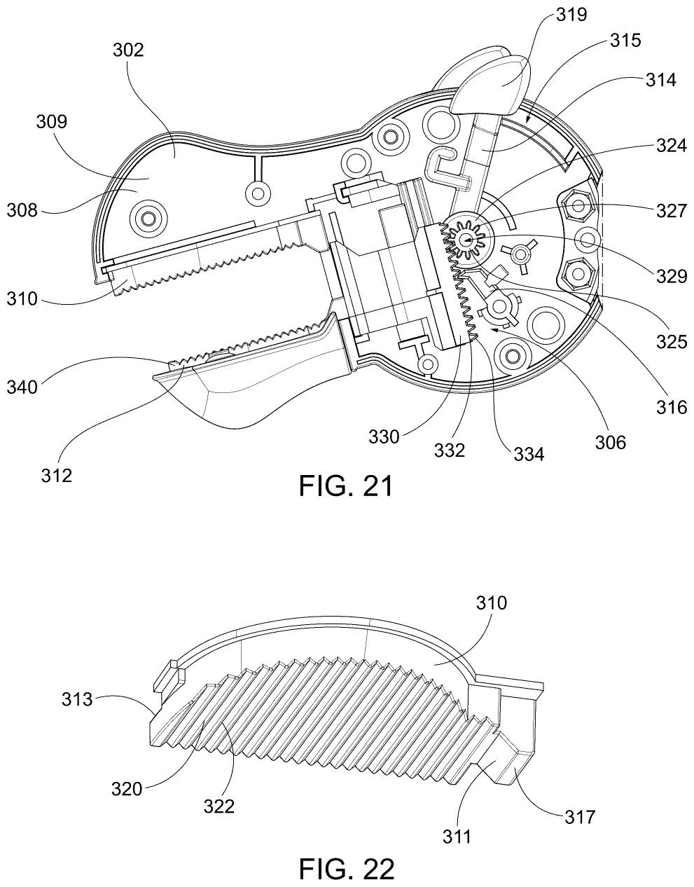

FIGS. 20-27 show another embodiment of a disclosed adjustable wrench 300. It is contemplated that the adjustable wrench 300 may have the same or similar features as those described with respect to the adjustable wrench 100 depicted in FIGS. 1-19B unless otherwise specified herein. FIG. 20 is a bottom isometric view of the adjustable wrench 300. FIG. 21 is a front elevation view of the head 302 of the adjustable wrench 300 of FIG. 20 with the front housing 307 and the jaw release button 318 removed to show the internal component parts of the adjustable wrench 300. As shown in FIGS. 20-21, the adjustable wrench 300 may include a head 302, a handle 304, and a jaw adjustment mechanism 306. The head 302 may include a housing 308. The housing 308 may be made of a single component or multiple components, for example, a front housing 307 and a rear housing 309. The head 302 may include a fixed jaw 310. The jaw adjustment mechanism 306 may include an adjustable jaw 312, a lever arm 314, a locking mechanism 316, and a jaw release button 318.

FIG. 22 is a bottom isometric view of the fixed jaw 310 of the adjustable wrench 300 of FIG. 20. The fixed jaw 310 may have a fixed jaw bottom surface 320 that includes a plurality of fixed jaw teeth 322. The fixed jaw 310 may have a fixed jaw first end 311 and a fixed jaw second end 313. The fixed jaw first end 311 may have a sloped or curved surface that extends away from the fixed jaw bottom surface 320. The fixed jaw first end 311 may define a fixed jaw stopping surface 317. The fixed jaw stopping surface 317 may be defined at an end of the sloped or curved surface. When the fixed jaw 310 is coupled to the housing 308, the fixed jaw first end 311 may be positioned closer to the lever arm 314 than the fixed jaw second end 313.

Components of the jaw adjustment mechanism 306 of the adjustable wrench 300 of FIG. 20 will now be discussed in more detail. As shown in FIG. 21, in the present embodiment, the lever arm 314 includes a lever grip 319 and a pinion gear 325 at an opposing end from the lever grip 319. The pinion gear 325 may include a plurality of pinion gear teeth 327 that surround a central pinion gear aperture 329. The pinion gear 325 may be coupled to a pivot point of the lever arm 314. The central pinion gear aperture 329 may align with a lever arm aperture defined in the lever arm 314, as discussed above. The lever arm 314 may include a circular base 324 at an opposing end from the lever grip 319. The circular base 324 may be a separable component from the lever arm 314 or an integrated component of the lever arm 314. The circular base 324 may define the lever arm aperture or may include a separate aperture that aligns with the lever arm aperture. The pinion gear 325 may be coupled to the circular base 324.

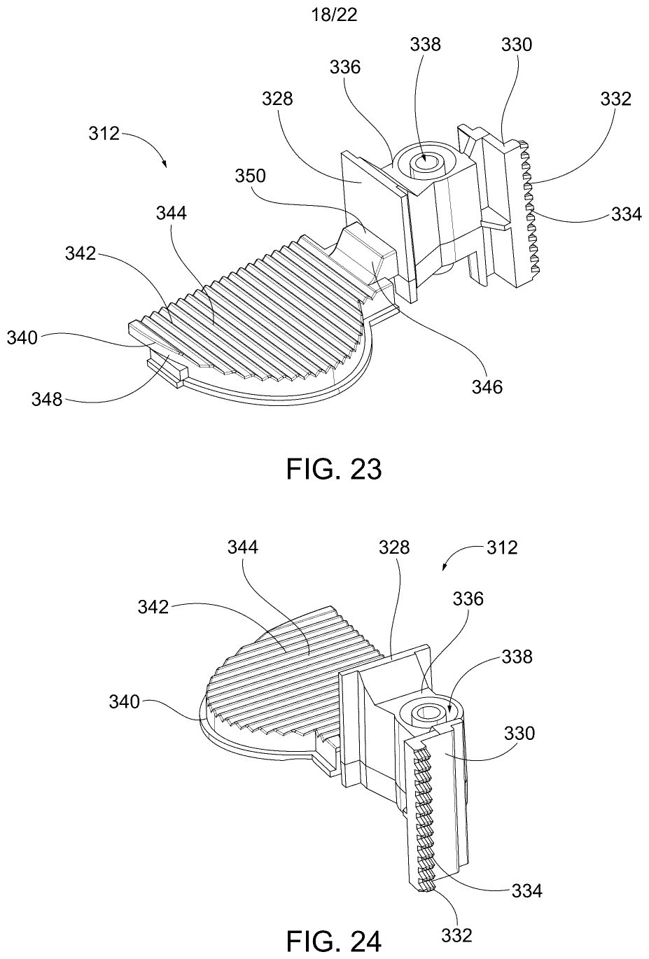

FIG. 23 is a left side top isometric view of the adjustable jaw 312 of the adjustable wrench 300 of FIG. 20. FIG. 24 is a right side isometric view of the adjustable jaw 312 of FIG. 23. As shown, the adjustable jaw 312 may include a left adjustable jaw wall 328 and a right adjustable jaw wall 330. The right adjustable jaw wall 330 may include a rack 332 that extends outward from an edge of the right adjustable jaw wall 330 and extends along a height of the right adjustable jaw wall 330. The rack 332 may extend from a portion of the right adjustable jaw wall 330 and may form an L-shape with the right adjustable jaw wall 330. The rack 332 may include a plurality of rack teeth 334. The plurality of rack teeth 334 may be positioned vertically along a height of the right adjustable jaw wall 330.

A spacer 336 may be positioned between the left adjustable jaw wall 328 and the right adjustable jaw wall 330. The spacer 336 may define a cylindrical channel or opening 338. For example, the jaw spring may be positioned within the cylindrical channel 338.

An adjustable jaw component 340 may be coupled to the left adjustable jaw wall 328. The adjustable jaw component 340 may be perpendicular to the left adjustable jaw wall 328 and the right adjustable jaw wall 330. The adjustable jaw component 340 may include an adjustable jaw component top surface 342 that includes a plurality of adjustable jaw teeth 344. The adjustable jaw component 340 may have an adjustable jaw first end 346 and an adjustable jaw second end 348. The adjustable jaw first end 346 may have a sloped or curved surface that extends away from the adjustable jaw component top surface 342. The adjustable jaw first end 346 may be coupled to the left adjustable wall 328. The slope of the adjustable jaw first end 346 may oppose or may be inverse to the slope of the fixed jaw first end 311. The adjustable jaw first end 346 may define an adjustable jaw stopping surface 350. The adjustable jaw stopping surface 350 may be defined at an end of the sloped or curved surface. When the adjustable jaw 312 is coupled to the housing 308, the adjustable jaw first end 346 may be positioned closer to the lever arm 314 than the adjustable jaw second end 348.

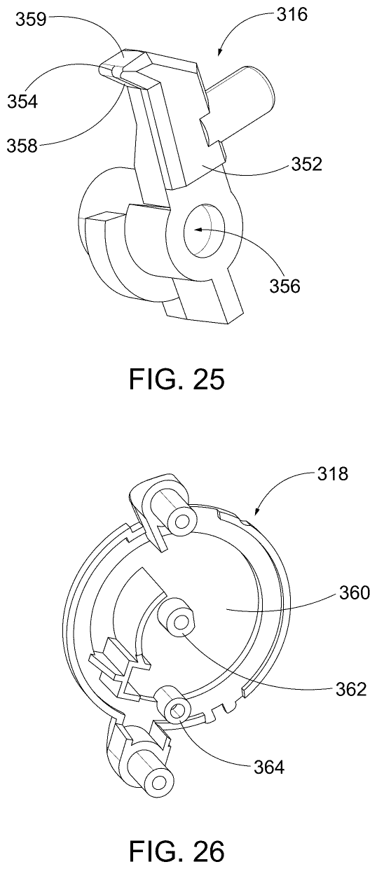

FIG. 25 is a left side isometric view of the locking mechanism 316 of the adjustable wrench 300 of FIG. 20. As shown, the locking mechanism 316 may have an elongated locking mechanism body 352 and a locking mechanism tip or tooth 354 that extends at an angle from the locking mechanism body 352. The locking mechanism body 352 may define a locking mechanism aperture 356 therethrough. The shape of the locking mechanism aperture 356 may correspond to the shape of the second jaw release button boss 364. The locking mechanism tip or tooth 354 may define a locking mechanism engagement surface 358 and a locking mechanism locking surface 359. The locking mechanism engagement surface 358 may be flat, curved, and/or sloped. The locking mechanism engagement surface 358 may have a slope that matches and aligns with a slope on a top surface of one or more of the rack teeth 334.

FIG. 26 is a rear right side isometric view of the jaw release button 318 of the adjustable wrench 300 of FIG. 20. As shown in the depicted embodiment, the jaw release button 318 may include a plurality of bosses that align with the different internal components of the adjustable wrench 300. As shown, the jaw release button 318 may include a rear jaw release button surface 360. A first jaw release button boss 362 may extend outward from the rear jaw release button surface 360. A second jaw release button boss 364 may extend from the rear jaw release button surface 360. Other bosses may extend out from the rear jaw release button surface 360, for example to couple the jaw release button 318 to the housing 308.

While the various components discussed above are described together in the embodiment of the adjustable wrench 300 depicted in FIGS. 20-27, it is contemplated that one or more of the above components may be omitted and replaced with a component of the adjustable wrench 100 depicted in FIGS. 1-19B and vice versa (a component described with respect to the adjustable wrench 300 of FIGS. 20-27 may replace a similar component of the adjustable wrench 100 of FIGS. 1-19B).

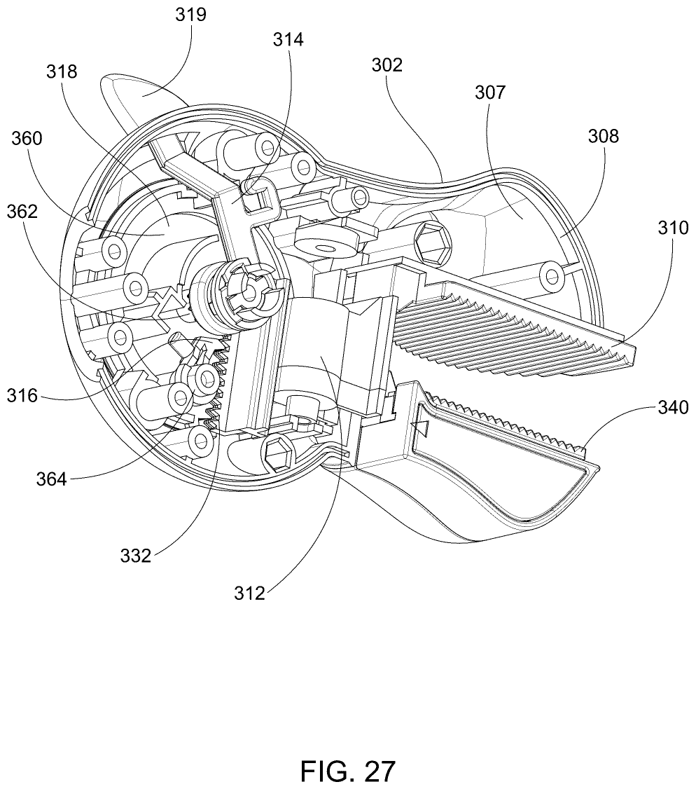

The arrangement of the components of the adjustable wrench 300 of FIG. 20 discussed above will now be discussed in more detail. FIGS. 21 and 27 show the internal component parts of the head 302 of the adjustable wrench 300 of FIG. 20. FIG. 27 is a rear right isometric view of the head 302 of the adjustable wrench 300 of FIG. 20 with the rear housing 309 removed. As shown, the fixed jaw 310 is coupled to a top portion of the housing 308 and the adjustable jaw 312 is coupled to a bottom portion of the housing 308. The fixed jaw 310 may be fixedly coupled to the housing 308 while the adjustable jaw 312 may be slidably or movably coupled to the housing 308. The adjustable jaw component 340 may be positioned parallel to the fixed jaw 310.

The lever arm 314 may engage with the adjustable jaw 312. Specifically, the pinion gear 325 may engage with the rack 332 on the right adjustable jaw wall 330. As shown in FIG. 21, the pinion gear teeth 327 may engage with the rack teeth 334. Specifically, the pinion gear teeth 327 may fit between rack teeth 334 and the rack teeth 334 may fit between pinion gear teeth 327.

The locking mechanism 316 may engage with the adjustable jaw 312. Specifically, the locking mechanism engagement surface 358 of the locking mechanism tip or tooth 354 may be biased against one of the rack teeth 334, e.g., against a top surface of one of the rack teeth 334. A bottom surface of an adjacent rack tooth of the rack teeth 334 may be biased against the locking mechanism locking surface 359 of the locking mechanism tip or tooth 354.

The jaw release button 318 may be coupled to the front housing 307. The first jaw release button boss 362 may be positioned through the pinion gear aperture 329 and, in some embodiments, through the lever arm aperture. The second jaw release button boss 364 may be positioned through the locking mechanism aperture 356 and may hold the locking mechanism 316 in place against the rack 332. In some embodiments, the lever arm 314 may be fixedly coupled to the first jaw release button boss 362. In some embodiments, the positioning of the first jaw release button boss 362 through the lever arm aperture and pinion gear aperture 329 may create a hinge for the lever arm 314. In other words, the lever arm 314 may be rotably or hingedly coupled to the first jaw release button boss 362. In some embodiments, the locking mechanism 316 may be fixedly coupled to the second jaw release button boss 364.

In operation, movement of the lever arm 314, or more specifically, movement of the lever grip 319, in a direction away from the fixed jaw 310 and towards the handle 304 may move the adjustable jaw 312 towards the fixed jaw 310. In the depicted embodiment, the adjustable jaw 312 may move upwards toward the fixed jaw 310. As the lever grip 319 is moved away from the fixed jaw 310, the lever arm 314 pivots, rotating the pinion gear 325 in a clockwise direction. As the pinion gear 325 rotates, it pushes the rack 332 in a direction towards the fixed jaw 310 (e.g., in an upward direction) so that the adjustable jaw 312 moves in a direction towards the fixed jaw 310. Specifically, the pinion gear teeth 327 that are engaged with the rack teeth 334 push the rack teeth upward until new rack teeth 334 (e.g., rack teeth 334 that are lower on the rack 332 than the previously engaged rack teeth 334) engage with the pinion gear teeth 327. As discussed in more detail above, the lever arm 314 may move the adjustable jaw 312 in increments, for example, 1/32″ each time the lever grip 319 is moved from one end to the other end of the lever aperture 315 defined in the housing 308. As the rack 332 moves upwards, the locking mechanism 316 slides into a lower position along the rack 332. The locking mechanism engagement surface 358 slides along the rack tooth of the rack teeth 334 to which it is engaged to engage with an adjacent rack tooth. The locking mechanism locking surface 359 may reengage with the bottom surface of an adjacent rack tooth to maintain an upward force (or a force that is in the direction of the fixed jaw 310) on the adjustable jaw 312 and to hold the rack 332 in place. The adjustable jaw 312 may be moved in increments until it comes in contact with the fixed jaw 310. For example, the fixed jaw stopping surface 317 and the adjustable jaw stopping surface 350 may come into contact, preventing the adjustable jaw 312 from moving closer to the fixed jaw 310 and preventing the adjustable jaw component top surface 342 from coming into contact with the fixed jaw bottom surface 320. In this manner, the curved surfaces of the fixed jaw 310 and the adjustable jaw 312 and the fixed jaw stopping surface 317 and the adjustable jaw stopping surface 350 function in the same manner as the jaw stopper 264 of the adjustable wrench 100 and may be considered the jaw stopper of the present embodiment of the adjustable wrench 300. By creating distance between the adjustable jaw component top surface 342 and the fixed jaw bottom surface 320, the sloped or curved fixed jaw and adjustable jaw first ends 311, 346, respectively, and the fixed jaw and adjustable jaw stopping surfaces 317, 350, respectively, (i.e., the “jaw stopper”) may allow for a safety margin, e.g., preventing users from pinching themselves between the jaws.

Movement of the jaw release button 318 may quickly release or separate the jaws 310, 312 of the adjustable wrench 300. Movement of the jaw release button 318 inwards may move the second jaw release button boss 364 and the locking mechanism 316 that is coupled thereto in a direction towards the rear housing 309. The locking mechanism 316 may be disengaged from the rack 332. When the locking mechanism 316 is disengaged, the upward force or counter force created by the locking mechanism locking surface 359 pushing against a bottom surface of a tooth of the rack teeth 334 is removed and the downward force or separation force of the jaw spring acting on the adjustable jaw 312 may push the adjustable jaw 312 in a direction away from the fixed jaw 310 (e.g., in a downward direction) until the jaw spring is in an extended position (and the jaw is in a fully open position) or the locking mechanism 316 is reengaged with the rack 332 by releasing the jaw release button 318. Releasing the jaw release button 318 may move the jaw release button 318 back to its original position.

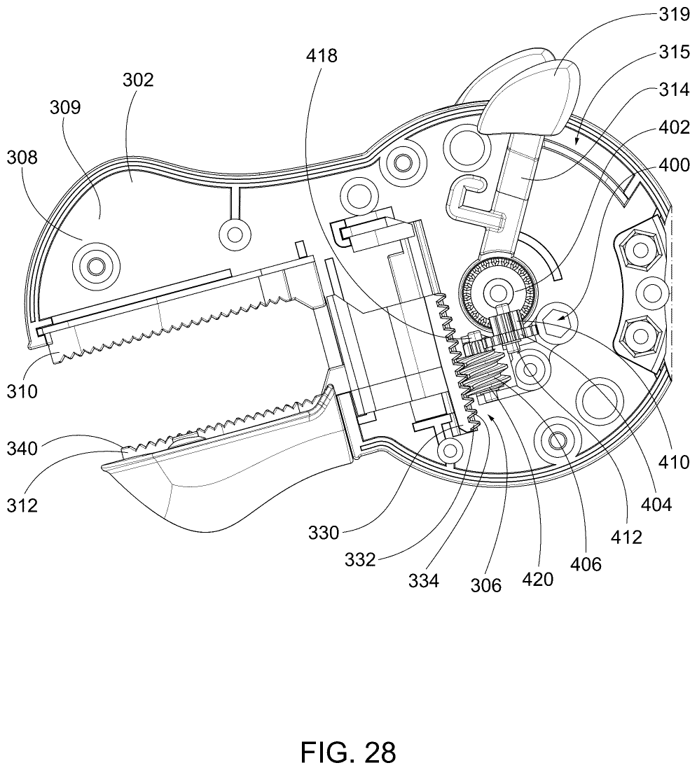

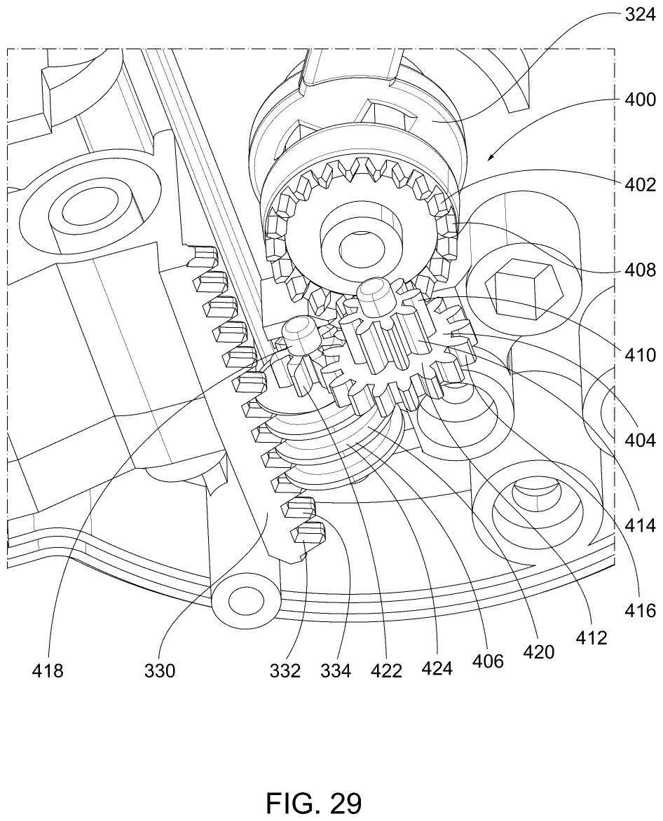

FIGS. 28-29 show an alternate embodiment of the adjustable wrench 300 of FIGS. 20-27 with different mechanics for moving the jaw adjustment mechanism 306. It is contemplated that the adjustable wrench 300 depicted in FIGS. 28-29 may have the same or similar features as those described with respect to the adjustable wrench 100 depicted in FIGS. 1-19B or the adjustable wrench 300 depicted in FIGS. 20-27 unless otherwise specified herein. FIG. 28 is a front elevation view of the head 302 of the adjustable wrench 300 with the front housing 307 and the jaw release button 318 removed to show the internal component parts of the alternate embodiment of the adjustable wrench 300. FIG. 29 is a zoomed-in top isometric view of the internal mechanical components of the jaw adjustment mechanism 306 of the adjustable wrench 300 of FIG. 28.

As shown in FIGS. 28-29, the jaw adjustment mechanism 306 may include a gear assembly 400, also called a gear transmission, that couples the lever arm 314 to the adjustable jaw 312. The gear assembly 400 may include one or more gears. In the depicted embodiment, the gear assembly 400 includes three separate gears. The gear assembly 400 may include a first gear 402, a second gear 404, and a third gear 406. As shown, the first gear 402 is coupled to the lever arm 314 at an opposing end from the lever grip 319. The first gear 402 may include a plurality of first gear teeth 408. The first gear 402 may be coupled to a pivot point of the lever arm 314. The first gear 402 may be coupled to the circular base 324. The first gear 402 may be any type of conventional gear. As depicted, the first gear 402 is a spur gear.

The second gear 404 may include one or more gears. As shown, the second gear 404 includes a top gear 410 and a bottom gear 412. While the second gear 404 is depicted as a single component, it is contemplated that the top gear 410 and the bottom gear 412 may be separate components coupled together. The top gear 410 may include top gear teeth 414 and the bottom gear 412 may include bottom gear teeth 416. The second gear 404 may include any type of conventional gear. As depicted, the top gear 410 and the bottom gear 412 are spur gears.

The third gear 406 may include one or more gears. As shown, the third gear 406 includes an upper gear 418 and a lower gear 420. While the third gear 406 is depicted as a single component, it is contemplated that the upper gear 418 and the lower gear 420 may be separate components coupled together. The upper gear 418 may include upper gear teeth 422 and the lower gear 420 may include lower gear teeth or threading 424. As shown, the lower gear 420 includes a spiral or helical thread. The third gear 406 may include any type of conventional gear. As depicted, the upper gear 418 is a spur gear and the lower gear 420 is a worm gear. The lower gear 420 may be a cylindrical gear. The lower gear 420 may be referred to as the adjustable jaw engagement gear.

The lever arm 314 may engage with the adjustable jaw 312 via the gear assembly 400. The first gear 402 may engage with the second gear 404. Specifically, the first gear 402 may engage with the top gear 410 of the second gear 402. The first gear teeth 408 may engage with the top gear teeth 414. The second gear 404 may engage with the third gear 406. Specifically, the bottom gear 412 of the second gear 404 may engage with the third gear 406. The bottom gear 412 of the second gear 404 may engage with the upper gear 418 of the third gear 406. The bottom gear teeth 416 of the second gear 404 may engage with the upper gear teeth 422 of the third gear 406.

The third gear 406 may engage with the rack 332 on the right adjustable jaw wall 330. Specifically, the threading 424 of the lower gear 420 (the adjustable jaw engagement gear or worm gear) may engage with the rack teeth 334. Specifically, a plurality of rack teeth 334 may fit between the grooves in the threading 424. In the depicted embodiment, the rack 332 may be a worm wheel that engages with the worm gear.

In the present embodiment, the locking mechanism 316 may be the third gear 406 or the gear assembly 400. The third gear 406 and/or gear assembly 400, or locking mechanism 316, may be coupled to the jaw release button 318. Movement of the jaw release button 318 inwards may move the third gear 406 and/or the gear assembly 400 that is coupled thereto in a direction towards the rear housing 309, disengaging the third gear 406, gear assembly 400, or locking mechanism 316 from the rack 332. When the third gear 406, gear assembly 400, or locking mechanism 316 is disengaged, the upward force or counter force created by the third gear 406, gear assembly 400, or locking mechanism 316 pushing against the rack 332 is removed and the downward or separation force of the jaw spring acting on the adjustable jaw 312 may push the adjustable jaw 312 in a direction away from the fixed jaw 310 (e.g., a downward direction) until the jaw spring is in an extended position (and the jaw is in a fully open position) or the third gear 406, gear assembly 400, or locking mechanism 316 is reengaged with the rack 332 by releasing the jaw release button 318. Releasing the jaw release button 318 may move the jaw release button 318 back to its original position.

In operation, movement of the lever grip 319 in a direction away from the fixed jaw 310 and towards the handle 304 may pivot the lever arm 314, rotating the first gear 402 in a clockwise direction. Rotation of the first gear 402 may rotate the second gear 404. Specifically, as the first gear 402 rotates, the first gear teeth 408 may push against the top gear teeth 414, rotating the second gear 404 in a counterclockwise direction. Rotation of the second gear 404 may rotate the third gear 406. Specifically, as the second gear 404 rotates, the bottom gear teeth 416 may push against the upper gear teeth 422 of the third gear 406, rotating the third gear 406 in a clockwise direction. As the lower gear 420 rotates, the threading 424 may push up against the rack teeth 334, pushing the rack 332 in a direction towards the fixed jaw 310 (e.g., in an upward direction) so that the adjustable jaw 312 moves in a direction towards the fixed jaw 310.

As discussed in more detail above, the lever arm 314 may move the adjustable jaw 312 in increments, for example, 1/32″ each time the lever grip 319 is moved from one end to the other end of the lever aperture 315 defined in the housing 308. In the present embodiment, the cylindrical or worm gear (the third gear 406) that engages the adjustable jaw 312 may allow for a smoother or more gradual movement of the adjustable jaw 312 towards the fixed jaw 310. The smooth movement of the adjustable jaw 312 created by the combination of the lever arm 314 and the cylindrical or worm gear may facilitate operation of the adjustable wrench 300 by a user with reduced coordination or dexterity, such as a child or elderly individual.

In the above embodiments disclosed in FIGS. 20-29, the disclosed adjustable wrench 300 may include a one-way ratchet function. Movement of the lever grip 319 and lever arm 314 in a direction away from the fixed jaw 310 and towards the handle 304, or in a rearward or backward direction, may engage the one or more gears 325, 402, 404, 406 to engage the rack 332 and to move the adjustable jaw 312 in a direction towards the fixed jaw 310. Movement of the lever grip 319 and lever arm 314 in the opposite direction, i.e., in a direction towards the fixed jaw 310 and away from the handle 304 or in a forward direction, may not engage the one or more gears 325, 404, 406 and/or may not engage the rack 332, such that the adjustable jaw 312 does not move.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, engaged, and joined) are to be construed broadly and may include intermediate members between a collection of elements and relative movement between elements unless otherwise indicated and may include wired or wireless connections, including electrical connections. As such, connection references do not necessarily infer that two elements are directly connected and in fixed relation to each other. As one example, connection references could indicate that the elements are biased against one another or are positioned adjacent to one another or otherwise interact with one another. The exemplary drawings are for purposes of illustration only and the dimensions, positions, order, and relative sizes reflected in the drawings attached hereto may vary.

While certain orders of operations are provided for methods disclosed herein, it is contemplated that the operations may be performed in any order and that operations can be omitted, unless specified otherwise.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

We claim:

1. An adjustable wrench, comprising:
a head comprising:
a housing that defines a housing cavity;
a fixed jaw coupled to the housing;
a jaw adjustment mechanism coupled to the housing, the jaw adjustment mechanism comprising:
an adjustable jaw comprising an adjustable jaw component positioned parallel to the fixed jaw; and
a lever arm positioned at least partially within the housing cavity, wherein the lever arm engages with the adjustable jaw, and wherein movement of the lever arm moves the adjustable jaw towards the fixed jaw; and
a handle coupled to the head.

2. The adjustable wrench of claim 1, wherein the jaw adjustment mechanism further comprises:
a locking mechanism positioned within the housing cavity, wherein the locking mechanism engages with the adjustable jaw and holds the adjustable jaw in place relative to the fixed jaw, and a jaw release button coupled to the housing and coupled to the locking mechanism, wherein movement of the jaw release button towards the housing cavity disengages the locking mechanism from the adjustable jaw to move the adjustable jaw away from the fixed jaw.

3. The adjustable wrench of claim 1, wherein the adjustable jaw further comprises an adjustable jaw wall coupled to the adjustable jaw component on a first side and positioned perpendicular to the adjustable jaw component, wherein the adjustable jaw wall comprises a rack on a second side, and wherein the rack comprises a plurality of rack teeth positioned vertically along a height of the adjustable jaw wall, and wherein the lever arm engages with the rack.

4. The adjustable wrench of claim 3, wherein the jaw adjustment mechanism further comprises at least one gear coupled to the lever arm, wherein the at least one gear engages with the rack.

5. The adjustable wrench of claim 4, wherein the at least one gear comprises a first gear coupled to the lever arm at a pivot point of the lever arm and wherein movement of an end of the lever arm in a direction away from the fixed jaw rotates the first gear in a clockwise direction resulting in the adjustable jaw moving towards the fixed jaw.

6. The adjustable wrench of claim 5, wherein the at least one gear further comprises a second gear and a third gear, wherein:
the second gear engages with the first gear and the third gear,
the third gear engages with the rack,
rotation of the first gear rotates the second gear and the third gear, and
rotation of the third gear pushes the rack in a direction towards the fixed jaw, moving the adjustable jaw towards the fixed jaw.

7. The adjustable wrench of claim 4, wherein movement of an end of the lever arm in a direction away from the fixed jaw pushes a gear tooth of the at least one gear upwards against a first rack tooth of the rack, pushing the adjustable jaw towards the fixed jaw.

8. The adjustable wrench of claim 3, wherein:
the jaw adjustment mechanism further comprises a worm gear that engages with the rack,
the lever arm engages with the adjustable jaw by engaging with the worm gear,
movement of the lever arm rotates the worm gear, and
rotation of the worm gear pushes the rack towards the fixed jaw and facilitates a smooth movement of the adjustable jaw towards the fixed jaw.

9. The adjustable wrench of claim 1, wherein the movement of the lever arm moves the adjustable jaw an incremental distance towards the fixed jaw, and wherein the incremental distance matches a diameter of a conventional fastener.

10. The adjustable wrench of claim 1, wherein:
the housing defines a lever aperture in a surface of the housing,
the lever aperture has a first end and a second end that define a length of the lever aperture therebetween,
the lever arm extends at least partially through the lever aperture, and
movement of the lever arm along the length of the lever aperture from the first end to the second end of the lever arm aperture moves the adjustable jaw 1/32″ towards the fixed jaw.

11. The adjustable wrench of claim 1, wherein the handle comprises two handle arms that extend out from the head.

12. The adjustable wrench of claim 1, wherein the lever arm is positioned proximate to a top surface of the head and adjacent to the handle enabling a user holding the handle with a hand to move the lever arm with one or more fingers of the hand.

13. The adjustable wrench of claim 1, wherein the fixed jaw comprises a fixed jaw bottom surface and a fixed jaw stopping surface and the adjustable jaw comprises an adjustable jaw component top surface and an adjustable jaw stopping surface, wherein the adjustable jaw stopping surface contacts the fixed jaw stopping surface to prevent the adjustable jaw component top surface from contacting the fixed jaw bottom surface and to create a gap between the fixed jaw and the adjustable jaw component.

14. A jaw adjustment mechanism for an adjustable wrench, comprising:
an adjustable jaw comprising:
an adjustable jaw component, and
an adjustable jaw wall coupled to the adjustable jaw component on a first side and positioned perpendicular to the adjustable jaw component, wherein the adjustable jaw wall comprises a rack on a second side; and
a lever arm comprising a first lever arm end and a second lever arm end, wherein the first lever arm end engages with the rack, and wherein movement of the second lever arm end in a direction away from the adjustable jaw pushes the rack and the adjustable jaw in a direction closer to a fixed jaw of the adjustable wrench.

15. The jaw adjustment mechanism of claim 14, wherein the first lever arm end engages with the rack via one or more gears, wherein a first gear of the one or more gears is coupled to a pivot point of the lever arm.

16. The jaw adjustment mechanism of claim 14, further comprising:
a jaw spring coupled to the adjustable jaw, wherein the jaw spring places a downward force on the adjustable jaw;
a locking mechanism comprising a locking mechanism surface that engages with the rack, wherein the locking mechanism places an upward force on the adjustable jaw that counters the downward force and holds the adjustable jaw in place; and
a jaw release button coupled to the locking mechanism, wherein movement of the jaw release button disengages the locking mechanism from the adjustable jaw and allows the adjustable jaw to move away from the fixed jaw.

17. An adjustable wrench, comprising:
a head comprising:
a housing that defines a housing cavity, wherein the housing defines a lever aperture on a top surface of the housing;
a fixed jaw coupled to a top portion of the housing;
a jaw adjustment mechanism coupled to a bottom portion of the housing, the jaw adjustment mechanism comprising:
an adjustable jaw comprising an adjustable jaw component coupled to an adjustable jaw wall on a first side of the adjustable jaw wall, wherein the adjustable jaw component is perpendicular to the adjustable jaw wall and parallel to the fixed jaw; and
a lever arm extending through the lever aperture and into the housing cavity, wherein the lever arm engages with the adjustable jaw wall on a second side of the adjustable jaw wall, and wherein movement of the lever arm moves the adjustable jaw towards the fixed jaw; and
a handle coupled to the head.

18. The adjustable wrench of claim 17, wherein a pivot point of the lever arm is coupled to a first gear and the adjustable jaw wall comprises a rack on the second side, and wherein the first gear engages with the rack, and wherein movement of the lever arm rotates the first gear such that the rack moves in a direction towards the fixed jaw.

19. The adjustable wrench of claim 18, wherein:
the jaw adjustment mechanism further comprises a cylindrical gear with helical threading,
the helical threading couples to rack teeth of the rack,
the first gear engages with the cylindrical gear to engage with the rack,
rotation of the first gear rotates the cylindrical gear, and
rotation of the cylindrical gear pushes the helical threading against the rack teeth to move the rack and the adjustable jaw in a direction towards the fixed jaw.

20. The adjustable wrench of claim 17, further comprising a jaw stopper coupled to one or both of the fixed jaw and the adjustable jaw, wherein the jaw stopper prevents a top surface of the adjustable jaw component from contacting a bottom surface of the fixed jaw.
